(19) United States
(12) Patent Application Publication
(10) Pub. No.: US 2020/0123809 A1
(43) Pub. Date: Apr. 23, 2020

(54) METHOD FOR OPERATING A MOTORIZED DOOR ADJUSTING DEVICE OF A MOTOR VEHICLE

(71) Applicant: Brose Fahrzeugteile GmbH & Co. Kommanditgesellschaft, Bamberg, Bamberg (DE)

(72) Inventor: Christian WEIDENBACHER, Donnersdorf (DE)

(73) Assignee: Brose Fahrzeugteile GmbH & Co. Kommanditgesellschaft, Bamberg, Bamberg (DE)

(21) Appl. No.: 16/657,157

(22) Filed: Oct. 18, 2019

(30) Foreign Application Priority Data
Oct. 19, 2018 (DE) 10 2018 217 912.3

(51) Int. Cl. E05B 47/00; B60J 5/04; B60W 50/10

(52) U.S. Cl. CPC E05B 47/0001; B60W 50/10; B60J 5/047

(57) ABSTRACT

A method for operating a motorized door adjusting device of a motor vehicle, comprising an actuator and a door driven by it. A closing command is detected, and the actuator is actuated to perform a closing process of the door. During the closing process, an activity of a user in an interior space of the motor vehicle is monitored, and if a designated activity is present, which indicates a desire of the user to exit, a warning signal is output. The invention further relates to a motorized door adjusting device of a motor vehicle.

### CROSS-REFERENCE TO RELATED APPLICATIONS

This application claims priority to German patent application Serial No. DE 10 2018 217 912.3 filed Oct. 19, 2018, the disclosure of which is hereby incorporated in its entirety by reference herein.

### TECHNICAL FIELD

The present disclosure relates to a motorized door adjusting device of a motor vehicle and a method of operating the same.

### BACKGROUND

To enhance the comfort, motor vehicles have electric motorized door adjusting devices. By means of an electric motor, a door of the motor vehicle is swiveled, thus freeing up an entry opening for a person. Usually a monitoring takes place during an opening movement by means of a distance sensor of a collision warning unit to make sure the door will not swivel against an obstacle, such as a curbstone or a post which was not or cannot be perceived by the user of the motor vehicle, for example because of an optical screening. If an obstacle is present, the electric motor is shut off or the door opening angle is restricted. This prevents the door from striking against the obstacle.

To further enhance the comfort, a closing movement of the door by means of the electric motor is also being provided increasingly. In this case, the electric motor is operated substantially only in the opposite direction. The movement range of the door can be scrutinized by the user, and normally no unwanted object can be positioned in the intervening distance, since the door has already passed through the range unhindered during the opening movement. Thus, for cost reasons, no collision monitoring directed toward the interior is provided.

However, it is possible that the user of the motor vehicle, after initiating the closing process, would like to exit from the motor vehicle once again. Thus, especially in the case of the driver of the motor vehicle, an exiting is necessary because of an external event, such as when a possible impairment of the driving safety of the motor vehicle has been discovered or when an additional activity needs to be performed. If the user is a child, it is furthermore possible that the child would like to get out to a parent. If this occurs, the user will get caught by the door, until a pinch protection responds. For this, a force exerted by the electric motor is monitored and when a limit value is passed the electric motor shuts off or reverses. However, in this case the door has already exerted a force on the user, so that an injury cannot be ruled out. At least the comfort is lessened, however.

Thus, after initiating the closing movement if the user would like to exit from the motor vehicle, it is necessary to hold the door open long enough for the pinch protection to respond. This requires the applying of a relatively large force, which cannot always be performed for example by frail persons or by children. Alternatively, it is necessary to wait until the closing movement is finished and the door has been closed. After this, the door must be opened once again.

### SUMMARY

The problem which this disclosure proposes to solve is to indicate an especially suitable method for operating a motorized door adjusting device of a motor vehicle and an especially suitable motorized door adjusting device of a motor vehicle for which in particular the safety and/or the comfort is enhanced.

In regard to the method, this problem may be solved by one or more methods of operating a motorized door adjusting device according to one or more embodiments.

The method serves for the operation of a motorized door adjusting device of a motor vehicle. The motor vehicle may be land-bound and is for example a passenger motor vehicle. Alternatively, the motor vehicle is a utility vehicle, such as a truck or a bus.

The motorized door adjusting device may include an actuator and a door driven by the actuator. For example, the actuator may include an electric motor, such as a brush-type commutator motor. The electric motor may be brushless such as a brushless DC motor (BLDC). In one or more embodiments, a spindle and/or a gearing may be arranged between the actuator and the door, such as a worm gear. A self-locking condition may be realized by means of the worm gear, so that an unintentional slamming of an open door is prevented. In summary, the door is moved by means of the actuator along a movement path during its operation.

The door in the mounted state is expediently attached to a bodywork of the motor vehicle and mounted by means of a bearing relative to it. For example, it is possible to swivel and/or slide the door relative to the bodywork. In other words, the door is thus a swiveling door or a sliding door. In particular, the door is a driver door or a passenger door or some other side door, such as the sliding door of a van or the like. In another alternative, the door is for example a trunk lid, which pivots about a horizontal axis for its opening. Expediently, all doors of the motor vehicle are driven by means of a respectively assigned actuator. In other words, the motor vehicle has exactly as many motorized door adjusting devices as there are doors.

The method calls for the detecting of a closing command. In particular, the door is in an opened state at this time. In other words, it is possible to enter the motor vehicle through an opening of the bodywork which is closed by the door in the intended state. For example, a switch is activated for issuing the closing command, which is arranged on the door and/or in an interior space of the motor vehicle. The switch for example is part of the motorized door adjusting device or at least the door. In one or more embodiments, the motorized door adjusting device is connected to an onboard computer of the motor vehicle in the installed state. Alternatively or in combination, the motorized door adjusting device is coupled to a bus system of the motor vehicle by signal technology, being for example a CAN bus system, a LIN bus system or a Flexray bus system. Expediently, the closing command is received via the bus system or the onboard computer and relayed to the motorized door adjusting device. This reduces the wiring and hardware expense.

After this, the actuator is actuated to perform a closing process of the door. In other words, the door is driven by means of the actuator so that the door is placed in a closed position. For example, the electric motor is suitably energized so that the door is closed. For example, the actuator is controlled or may be regulated to a given speed. In particular, the speed may be constant or it may be dependent on the current position of the door. For example, the door is closed directly after detecting the closing command. Alternatively, there is a waiting for a particular time, such as 0.5 seconds to 3 seconds, or between 1 second and 2 seconds. Expediently, a tone is output during the closing movement, such as by means of a buzzer or loudspeaker.

During the closing process, i.e., while the door is being moved, or at least after the closing command has been detected, an activity of the user is monitored. For example, all activities of the user are monitored. In particular, it is monitored whether a designated activity of the user is present. The designated activity indicates the driver's wish to exit. In other words, the designated activity is performed when the user would like to exit from the motor vehicle through the door. In summary, the designated activity corresponds to the user's wish to leave the motor vehicle, for example through the door, which is presently closed. In other words, the designated activity is used in particular as the user's wish to halt the closing movement.

In summary, monitoring is performed for the designated activity of the user. The user may be associated with the door that is being closed owing to the closing process. As an example, the user is located on a seat associated with the same door, as long as this is situated in the interior space of the motor vehicle. In other words, the activities are monitored for the user who is situated on a seat associated with the door. If the designated activity is present, indicating the user's wish to exit, a warning signal is output. In summary, monitoring is performed for the presence of the external designated activity as a condition and when this is fulfilled the warning signal is output.

The designated activity is in particular an external activity and not a direct activating of the motorized door adjusting device. Expediently, therefore, no operating of the motorized door adjusting device and/or no contact between the user and the motorized door adjusting device, such as the door, takes place. In other words, there is no direct operating of the door or the motorized door adjusting device by the user. The designated activity is thus substantially independent of the motorized door adjusting device. In summary, in particular, a check is made for the presence of the external activity as an external condition, i.e., a designated situation in which the user makes no direct contact with or has no direct influence on the motorized door adjusting device. Hence, the designated activity is not an operating of a switch or the like and thus no direct active input. As one example, the designated activity is performed in an interior space of the motor vehicle, such as only in the interior space.

Thus, owing to the monitoring of the user's activity, the user's wish to exit may be inferred indirectly. In this case, the warning signal is output, so that it is recognizable to the user that the closing process was already started. Owing to the warning, the user is deterred for example from getting out of the motor vehicle or at least paying attention to the door. Therefore, the safety is enhanced for the user.

The activity of the user is for example detected directly or indirectly. In other words, an active operating of a definite element by the user is not necessary. Thus, safety may be further enhanced. Expediently, monitoring may be performed for an activity of the user when the user is situated inside the motor vehicle. Thus, it is only necessary to monitor a relatively small spatial volume for the activity of the user, so that also comparatively few sensors are enough for this. Consequently, the production costs are reduced.

If the designated activity is not present, the closing movement will expediently continue until the door is closed and finds itself in a closed position. The method is then expediently ended. In other words, the door is closed at the end of the method. As an example, the warning signal will not be output.

The designated activity involves for example a subactivity. The subactivity may be a changing of a seat position. In other words, monitoring is performed for a changing of a seat position of the user and the warning signal is output in dependence on this. The user will change his seat position when he wishes to get out or when an object situated outside the motor vehicle awakens his interest. Consequently, the warning signal will be output upon changing of the seat position, while no active operating of the motorized door adjusting device will be required. Thus, the safety of the user is enhanced. Also, the warning signal will thus be output in particular in the event of a partial exiting of the user from the motor vehicle.

The seat position is detected for example by means of a seat occupancy detection. For example, it is checked whether the seat has been completely vacated, or whether the weight of the user has shifted in the direction of the door, such as is required for an exiting. A seat occupancy detection is required for the triggering of safety devices, such as airbags or seatbelt tighteners, so that these are already present. Thus, if such a subactivity is chosen, no additional sensors are required, which reduces the production costs.

Alternatively, there is a checking for a change of the seat position by means of an interior space sensor, comprising a camera for example. The camera is expediently sensitive in the infrared range, so that the user can be detected relatively efficiently. Alternatively or in combination with this, the camera is sensitive in the visible spectrum. In another alternative embodiment, the interior space sensor may include a radar or ultrasound sensor, by means of which the user and thus his seat position are detected. A travel time difference is used in particular for this. Expediently, the interior space sensor is a TOF camera (“Time of Flight” camera) or it expediently may include such a camera.

In one alternative to this, the subactivity is an opening of a seatbelt. For example, a seatbelt buckle is opened, which is expediently detected by means of a sensor associated with the seatbelt buckle. Alternatively or in combination with this, a rolling up of the seatbelt is registered. In other words, the opening of the seatbelt is the rolling up of a seatbelt roller associated with the seatbelt. The rolling up is expediently detected by means of a sensor associated with the seatbelt roller. Such sensors are already installed in the motor vehicle to provide for safety functions, so that no additional components are needed, and the production costs are not increased. When the user opens the seatbelt, usually the user would like to get out of the motor vehicle, or reorient himself. Thus, owing to the issuing of the warning signal, the user is made aware of the closing process. This enhances the safety.

In another alternative, the subactivity is a grasping of the steering wheel in an upper quadrant, such as a so-called 12 o'clock position. The door in this case is expediently the driver-side door. If the driver as the user wishes to get out, he will grasp the steering wheel for example in the upper quadrant, so that he can pull himself out from the seat. In another alternative, the subactivity involves the grasping of a door frame, i.e., a region against which the door lies in the closed condition. This also will be performed by the user in order to pull himself out from the seat. In another alternative, the subactivity is an activating of a handle, such as one attached to the door. In another alternative, the subactivity is a particular pattern of eye movement. In other words, a so-called eyetracking method is used. If the eyes of the user are moved in the defined pattern, the subactivity is present. The pattern corresponds in particular to a view directed at the surroundings of the motor vehicle, i.e., to the outside.

For example, the designated activity is formed by means of the subactivity. In one or more embodiments, however, the designated activity may include at least two different subactivities and is expediently formed by means of them. Consequently, if two different subactivities are present, the warning signal will be output. For example, it is necessary for the subactivities to be performed in a definite sequence. As another example, however, the time sequence of the subactivities is not critical to the presence of the designated activity. Owing to the two subactivities, a wrong issuing of the warning signal is prevented or at least reduced.

For example, the warning signal is output optically and/or acoustically. Thus, the user will be made aware of the movement of the door. As another example, however, the actuating of the actuator will be changed in order to issue the warning signal. In this case, the wish of the user will be granted without them having to specially operate the motorized door adjusting device. Consequently, the comfort is enhanced. No direct activation of the motorized adjusting device is required for this, and no direct activation or holding open of the door, so that a pinching is prevented and thus the safety is enhanced. The user's feeling of safety is also enhanced, since the user does not have to grab the moving door, and thus does not have to fear getting pinched by it.

For example, the actuator will be operated more slowly and thus the closing process will be delayed. Thus, it is for example possible for the user to still briefly leave the motor vehicle or give a message to a person standing outside the vehicle. In one alternative, for example, the actuator will continue to operate, especially at the same speed. However, expediently any pinch protection which is present will be operated with an altered parameter. In particular, a parameter serving to identify a pinching will be decreased. Expediently, a required force exerted and/or a required torque exerted and resulting in the triggering of the pinch situation will be decreased. In other words, the pinch protection is set more sensitively. If the user is getting out, he can hold the door open already by means of a relatively minor opposite pressure. But if the user does not want to leave the motor vehicle, the door will still be closed in the desired time. In another alternative, the actuator will be reversed, i.e., the closing movement will be ended and switched to an opening movement. Thus, the opening of the motor vehicle which can be closed by means of the door is freed up, so that the user can get out unhindered.

In one or more embodiments, however, the actuator will be shut off. In other words, in order to change the actuation of the actuator it will be shut off. Consequently, when the designated activity is present, the actuator will be shut off and the closing movement ended. If the user wishes to get out of the motor vehicle, and thus consciously or unconsciously performs the designated activity, an exiting is possible owing to the shutdown. If the user has only inadvertently performed the designated activity, only a comparatively slight movement is required in the renewed commencement of the closing movement, so that the time delay is not excessive. This also further provides for comfort.

For example, the actuator is shut off until a renewed activation of the motorized door adjusting device, i.e., until receiving a new closing command. Alternatively, the shutdown occurs only for a particular time, which is for example between 5 seconds and 1 minute or between 10 seconds and 20 seconds. If the user wishes to get out of the motor vehicle, this time is sufficient, without the user getting pinched by the door. If the user does not wish to get out of the motor vehicle, the closing movement will be resumed after the time period and thus the door will be completely closed. Thus, a closing of the door is always assured, which heightens the comfort.

For example, the monitoring is performed only when the closing command has been issued outside of the motor vehicle. For example, a monitoring is thus performed only when the closing command is issued outside the motor vehicle, or the presence of a further condition is also required for this. Expediently, the closing command will be issued by means of a radio key or the like, with the user being inside the motor vehicle. Since the closing command was issued outside the motor vehicle, it is not always evident to the person issuing the closing command whether the user wishes to get out of the motor vehicle or not. Since the warning signal is output in dependence on the designated activity of the user, who did not issue the closing command for example, it is evident to the latter that the closing movement has started, which enhances the safety.

Alternatively or in combination with this, the monitoring is performed at least only when the user is a child or a small-sized person. For example, the height of the user is determined by means of an interior sensor and this is used to determine whether the user is a child or a small-sized person. In the case of a child, a predictable behavior is not always present, and the child may wish to get out, for example after positioning himself in the motor vehicle. Owing to the method, a pinching of the child by the door is avoided or at least mitigated, since the danger of injury is already higher in the case of a child. In particular, the monitoring is performed at least only if a child safety seat has been positioned on a seat associated with the motorized door adjusting device. Expediently, it is inferred from the presence of the child safety seat that the user is a child. For example, the child safety seat is held on the seat by means of a suitable retention system. In this case, the presence of the child safety seat is registered by means of the retention system and thus the child safety seat is detected. Alternatively or in combination with this, the monitoring is performed at least only when a child safety is activated for the motorized door adjusting device, i.e., an opening by an activation in the interior space is not possible or is deactivated, in particular.

Expediently, the monitoring is performed at least only when a user input has occurred, i.e., when user input has occurred already before the detecting of the closing command. The user input occurs for example by means of the programming of a controller of the motorized door adjusting device and/or an onboard computer of the motor vehicle. As one example, the user input may be saved in memory of the controller and/or the onboard computer of the motor vehicle. For example, a marking (“flag”) is set there on the basis of user input. On the basis of the user input, there occurs in particular an activation of the monitoring and thus also the changing of the energization when the designated activity is present. Thus, the monitoring can be activated on the basis of the user input. If the user does not desire any monitoring, this can be deactivated, so that a reliable closing of the door is constantly assured and a possible delay is prevented. If needed, the monitoring can be activated, which enhances the comfort. In particular, the monitoring is activated/deactivated until further user input occurs.

The motorized door adjusting device is a component of a motor vehicle, such as a passenger motor vehicle, which is for example a van, a sedan, or a station wagon. Alternatively, the motor vehicle is a bus, for example. However, the motor vehicle serves at least for the transporting of persons. The motorized door adjusting device may include an actuator as well as a door driven by it. Expediently, the actuator and the door are suitably in operative connection with each other, so that in the installed condition when the actuator is operated the door is moved along a movement path. For example, the door is opened or closed.

As another example, the door may be operatively connected to the actuator by a gearing. The gearing expediently may include a worm gear. In particular, the worm gear is self-locking, so that a self-locking is realized. In one or more embodiments, the motorized door adjusting device may include a spindle, which is driven by means of the actuator, wherein the door is secured for example to a component of the spindle. Furthermore, the motorized door adjusting device may include a controller, having for example a programmable microprocessor. Alternatively, the controller is formed for example by means of an application-specific integrated circuit (ASIC) or may include at least such a circuit.

The motorized door adjusting device is operated according to a method in which a closing command is detected, and the actuator is actuated to perform a closing process of the door. During the closing process, an activity of a user in an interior space of the motor vehicle is monitored, and if a designated activity is present, indicating a wish of the user to get out, a warning signal is output. The method is expediently carried out at least partly by means of the controller, which is suitable for this, in particular provided and set up for this. A portion of the motorized door adjusting device, such the controller, may include an interface, which in the installed condition is coupled to a bus system of the motor vehicle. The interface may be connected to the possibly present bus system of the motor vehicle. Through the interface, the inputting of the closing command to the motorized door adjusting device may occur. Alternatively, or in combination with this, an inputting of the activity of the user in particular occurs via the interface. In other words, a suitable sensor is coupled by signal technology to the interface. For example, the sensor is a component of the motorized door adjusting device and is coupled to the interface of the controller. Alternatively, the sensor is for example independent of the motorized door adjusting device and is a component of the motor vehicle.

The actuator for example is a pneumatic or hydraulic actuator. As another example, the actuator may include or may be an electric motor. The electric motor is for example a brush-type commutator motor. As another example, however, the electric motor is brushless and is for example a brushless DC motor (BLDC). As one example, the electric motor may be a synchronous motor, alternatively an induction motor.

The benefits and modifications mentioned in connection with the method are also applicable mutatis mutandis to the motorized door adjusting device and vice versa.

### BRIEF DESCRIPTION OF THE DRAWINGS

In the following, an exemplary embodiment of the invention shall be explained more closely with the aid of a drawing. There are shown:

FIG. 1 schematically, a motor vehicle with a motorized door adjusting device, and

FIG. 2 a method for operating the motorized door adjusting device.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Corresponding parts are given the same reference numbers in all the figures.

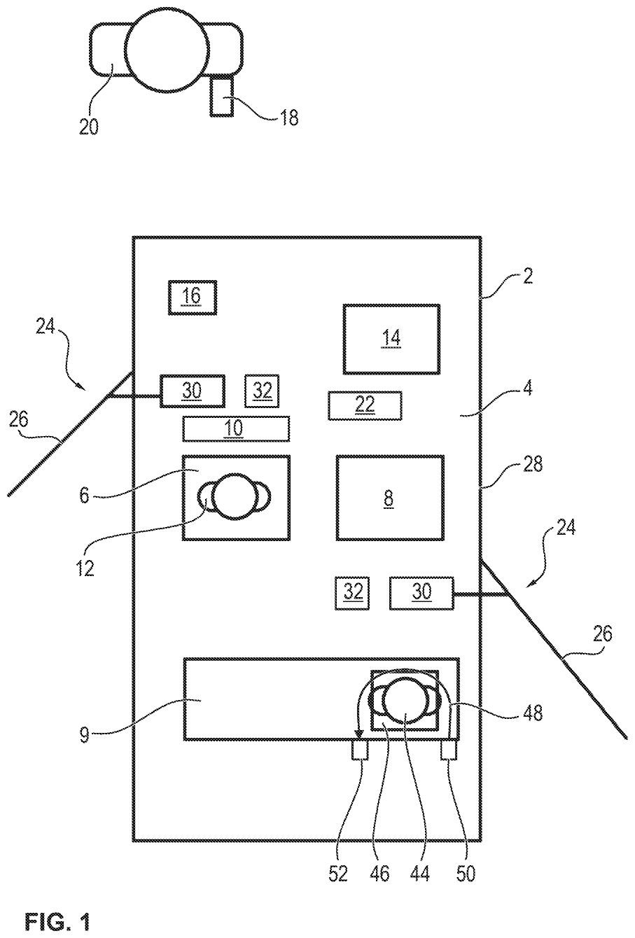

FIG. 1 shows schematically a simplified motor vehicle 2 in the form of a passenger motor vehicle. The motor vehicle 2 may include an interior space 4, inside which are arranged a driver seat 6, a passenger seat 8 and a rear seat bench 9. In front of the driver seat 6 is arranged a steering wheel 10, by means of which a direction of movement during the advancing motion of the motor vehicle 2 can be manually adjusted by a driver 12. The motor vehicle 2 furthermore may include an onboard computer 14, which is coupled by means of a bus system, not otherwise shown, to a receiving unit 16 by signal technology. By means of the receiving unit 16, a reception of radio signals occurs during operation, which are sent out by a person 20 activating a radio key 18. Furthermore, the motor vehicle 2 may include a user interface 22, by means of which the onboard computer 14 can be set up by the driver 12 or other persons.

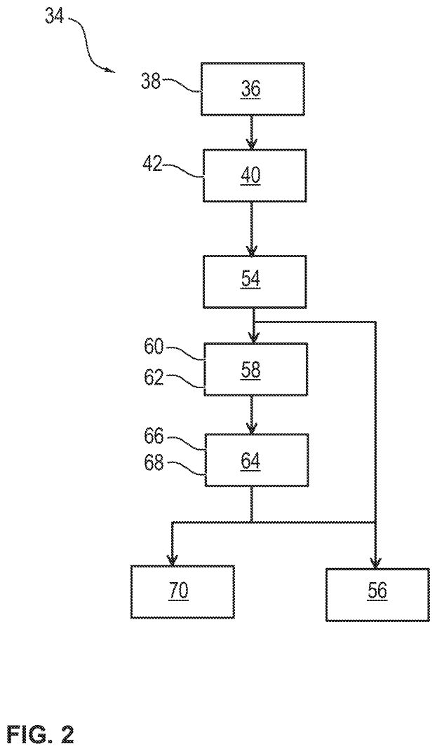

Moreover, the motor vehicle 2 may include a total of four motorized door adjusting devices 24, two of which are shown. In each case one of the motorized door adjusting devices 24 is associated with the driver seat 6 and the passenger seat 8, and two are associated with the rear seat bench 9, the motorized door adjusting device 24 associated with the driver seat 6 and one of the motorized door adjusting devices 24 associated with the rear seat bench 9 being shown. Each of the motorized door adjusting devices 24 may include a door 26, which is pivotably mounted on a bodywork 28 by bearings, not otherwise shown. Moreover, each motorized door adjusting device 24 may include an actuator 30 in the form of an electric motor. The actuator 30 here is formed by means of the electric motor. The respectively associated door 26 is driven by means of the electric motor 30, so that when the electric motor 30 is energized, the respective door 26 is opened or closed. Furthermore, each motorized door adjusting device 24 may include a controller 32, by means of which the respectively associated electric motor 32 is energized. The controllers 32 are connected by means of the bus system to the onboard computer 14 using signal technology. With the exception of the configurations of the respective door 26, the motorized door adjusting devices 24 are identical in design and are in each case operated according to a method 34 which is represented in FIG. 2.

The method calls for detecting a user input 38 in a first step 36. The user input 38 is operated by means of the user interface 22 and from there it is transmitted to the onboard computer 14 and also saved there. From the onboard computer 14, the user input 38 is transmitted to the controllers 32 of the motorized door adjusting devices 24 and saved there. Depending on the user input 38, a marking (flag) is set. In particular, the marking is set upon delivery of the motor vehicle 2 and can thereafter be changed by the user at any time. In other words, it is possible to perform the first work step 36 as often as desired and at any given time.

In a second work step 40, a closing command 42 is detected. The closing command 42 for example is issued by means of the radio key 18 by the person 20. Prior to issuing the closing command 42, the person 20 had placed a child 44 on a child safety seat 46, which is positioned on the rear seat bench 9 and secured there. Here, the child 44 is secured by means of a seatbelt 48, which is unrolled from a seatbelt roller 50 and inserted into a seatbelt buckle 52. After the positioning and the buckling up of the child 44, the person 20 would like to sit down on the driver seat 6. At least the motor vehicle 2 needs to be moved, for which the door 26 associated with the rear seat bench 9 needs to be closed. This wish is signaled by means of the closing command 42.

In a following third work step 54, the electric motor 30 is energized in order to perform a closing process of the door 26, i.e., the actuator is suitably actuated. In other words, the door 26 is driven and swiveled toward the bodywork 28. The third work step 84 occurs in particular at a particular time after the second work step 40, the time being between 0.5 seconds and 1.5 seconds.

Provided the user input 38 corresponds to a setting for which no monitoring should be performed, the door 26 will be swiveled until it rests against the bodywork 28. Then a fourth work step 56 is carried out and the energizing of the electric motor 30 stops. Furthermore, the door 26 is locked to the bodywork 28, so that an unintentional opening is prevented.

If the user input 38 corresponds to a monitoring, after the third work step 54 a fifth work step 58 is performed and an activity 60 of the child 44 is monitored, who is thus used as a user 62. During the fifth work step 58, basically all the activities 60 of the child 44 are detected with all available sensors. The fifth work step 58 and the monitoring are only performed when the user input 38 has been performed accordingly. Furthermore, the fifth work step 58 and thus the monitoring are only performed if the closing command 42 was issued outside the motor vehicle 2, i.e., by means of the radio key 18. Moreover, the monitoring is only performed if the child safety seat 46 is positioned on the rear seat bench 9, i.e., on the seat associated with the motorized door adjusting device 24. From this, it is inferred that the child 44 is the user 62. If one of these conditions is not met, the monitoring and thus the fifth work step 58 is not performed and the electric motor 30 is energized until such time as the door 26 rests against a bodywork 28. Then the fourth work step 56 is performed once again. Thus, for example, the fifth work step 58 is not performed if no child safety seat 46 is positioned on the rear seat bench 9.

In a sixth work step 64 following the fifth work step 58, the activities 60 are compared to a designated activity 66. The designated activity 66 indicates a wish of the user 62 to exit and consists of two different subactivities 68. One of the subactivities 68 is an opening of the seatbelt 48, which is detected by means of a sensor associated with one of the seatbelt rollers 50 or the seatbelt buckle 52. The other subactivity 68 is a particular eye movement of the child 44, during which the eyes are directed from the interior space 4 of the motor vehicle 2 to its surroundings. An alternative subactivity 68 is, for example, a certain weight shifting of the child 44 on the child safety seat 46.

If the two subactivities 68 are present, the designated activity 66 is also present, and after this a seventh work step 70 is performed and a warning signal is output. As the warning signal here, the actuator 30, i.e., the electric motor 30, is shut off. Thus, the door 26 is halted, and it is possible for the child 44 to get out of the motor vehicle 2 without getting pinched by it. Moreover, a loudspeaker not otherwise represented is activated as the warning signal. Thus, the person 20 can notice that the child 44 has unbuckled his seatbelt and would like to get out of the motor vehicle 2. In summary, in the seventh work step 70 the energizing of the electric motor 30 is altered, and the seventh work step 70 is performed only when the designated activity 66 is present.

If the designated activity 66 is not present, the door 26 is swiveled until it rests against the bodywork 28 and the fourth work step 56 is performed. In this case, the monitoring of the activity 60 of the user 62 is ended.

In another alternative, the fifth work step 58 is also performed if the closing command 42 is issued inside the motor vehicle 2. In this case as well, expediently no child safety seat 46 is required. For example, if the driver 12 would like to exit after activation of the motorized door adjusting device 24 associated with the driver seat 6, i.e., if the closing command 42 has already been detected and the associated electric motor 30 is already energized, the activity 60 of the driver 12 is monitored during the fifth work step 58, who is thus used as the user 62.

In the sixth work step 64, the activity 60 is compared to the designated activity 66, which once again consists of the two subactivities 68, which are different from each other. As possible subactivities 68, the same subactivities 68 as used for the child 44 may be used. In addition, one possible subactivity 68 is the changing of a seat position of the driver 12, i.e., a shifting of his weight in the direction of the door 26. In addition, a grasping of the steering wheel 10 in an upper quadrant, i.e., in a 12 o'clock position, is used as the subactivities 68. Once again, insofar as two of the mentioned subactivities 68 different from each other are present, the designated activity 66 is present, and the seventh work step 70 is performed. Once again, the warning signal is output and thus the electric motor 30 is shut off. The designated activity 66 is an external activity, as when using the child 44 as the user 62, i.e., not an influencing of the motorized door adjusting device 24 directly or an active issuing of a command for the motorized door adjusting device 24, such as by means of the radio key.

In summary, during the ongoing motorized closing process of the door 26 the closing process is altered if the designated activity 66 indicating a desire to exit is present. For example, the closing process is interrupted or slowed down. In another alternative, the closing process is continued with altered pinch protection parameters. Alternatively or in combination with this, a warning tone or a warning message is output when the designated activity 66 is present.

The designated activity 66 expediently consists of one or two different subactivities 68. The subactivity 68 is ascertained for example by means of a seat occupancy detection, an interior sensor (camera or radar), with the aid of an activating of the seatbelt buckle 52 or a rolling up of the seatbelt roller 50, with the aid of a grasping of the steering wheel 10, especially in a 12 o'clock position, or by grabbing a door frame or door handle.

In particular, the monitoring is only performed when the closing command 42 is issued outside the motor vehicle 2 and sent from there to the motor vehicle 2. Expediently in this case the closing command 42 is issued by means of the radio key 18 or a smartphone. In this case, namely, a heightened risk of injury exists for the user 62, since the operator of the radio key 18, i.e., the person 20, cannot fully see the motor vehicle 2. Alternatively or in combination with this, the monitoring is performed at least only when the child 44 or the child safety seat 46 is present, associated with the respective motorized door adjusting device 24. Owing to the method 34, the safety is enhanced, since there is less risk of injury.

The invention is not confined to the exemplary embodiment described above. Instead, other variants of the invention can also be derived from this by the person skilled in the art, without leaving the subject matter of the invention. In particular, moreover, all individual features described in connection with the exemplary embodiment may also be combined in another manner, without leaving the subject matter of the invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE SYMBOLS

2 Motor vehicle
4 Interior space
6 Driver seat
8 Passenger seat
9 Rear seat bench
10 Steering wheel
12 Driver
14 Onboard computer
16 Receiving unit
18 Radio key
20 Person
22 User interface
24 Motorized door adjusting device
26 Door
28 Bodywork
30 Actuator/electric motor
32 Controller
34 Method
36 First work step
38 User input
40 Second work step
42 Closing command
44 Child
46 Child safety seat
48 Seatbelt
50 Seatbelt roller
52 Seatbelt buckle
54 Third work step
56 Fourth work step
58 Fifth work step
60 Activity
62 User
64 Sixth work step
66 Designated activity
68 Subactivity
70 Seventh work step

1. A method of operating a motorized-door adjusting device of a motor vehicle provided with a door and actuator configured to drive the door, the method comprising:
detecting a closing command;
actuating the actuator to perform a closing process of the door;
monitoring an activity of a user in an interior space of the motor vehicle during the closing process; and
outputting a warning signal in response to detecting a designated activity indicative of a desire of the user to exit the interior space.

2. The method of claim 1,
wherein
the designated activity includes a sub activity, wherein the sub activity includes changing of a seat position, an opening of a seatbelt, grasping of a steering wheel in an upper quadrant, or a definite pattern of eye movement.

3. The method of claim 2,
wherein
the designated activity includes at least two different sub activities.

4. The method of claim 1, further comprising shutting of the
actuator after the outputting step.

5. The method of claim 1,
wherein
the monitoring step is performed in response to detecting a closing command from outside the motor vehicle.

6. The method of claim 1,
wherein
the monitoring step is performed in response to the user being a child and/or in response to a child safety seat positioned on a seat assigned to the motorized door adjusting device.

7. The method of claim 1,
wherein
the monitoring step is performed in response to a user input.

8. A motorized door adjusting device for use in a motor vehicle, the motorized door adjusting device comprising:
a door;
an actuator configured to move close the door; and
a controller configured to output a warning signal in response to detecting a designated activity indicative of a desire of the user to exit an interior space of the motor vehicle.

9. The motorized door adjusting device of claim 8,
wherein
the actuator includes an electric motor.

10. The motorized door adjusting device of claim 8, wherein the designated activity includes changing a position of a seat.

11. The motorized door adjusting device of claim 8, wherein the designated activity includes opening of a seatbelt.

12. The motorized door adjusting device of claim 8, wherein the designated activity includes grasping of a steering wheel in an upper quadrant.

13. The motorized door adjusting device of claim 8, wherein the designated activity includes a definite pattern of eye movement.

14. The motorized door adjusting device of claim 8, wherein the controller is further configured to receive signals from a sensor, configured monitor activity of a user in an interior space of the motor vehicle, in response to the actuator closing the door.

15. A motorized door adjusting device for use in a motor vehicle, the motorized door adjusting device comprising:
a door;
an actuator configured to move close the door; and
a controller configured to receive signals from a sensor to monitor activity of a user in an interior space of the motor vehicle, in response to the actuator closing the door.

16. The motorized door adjusting device of claim 15, wherein the controller is further configured to output a warning signal in response to detecting a designated activity indicative of the user's desire to exit the interior space.

17. The motorized door adjusting device of claim 15, wherein the controller is further configured to, responsive to receiving signals indicative of a user input, monitor the activity of the user in the interior space of the motor vehicle.

18. The motorized door adjusting device of claim 15, wherein the controller is further configured to, responsive to receiving signals indicative of a child being in the interior space of the motor vehicle, monitor the activity of the user in the interior space of the motor vehicle.

19. The motorized door adjusting device of claim 15, wherein the controller is further configured to, responsive to receiving signals indicative of a child seat disposed in the interior space of the motor vehicle, monitor the activity of the user in the interior space of the motor vehicle.

20. The motorized door adjusting device of claim 19, wherein the controller is further configured to, responsive to receiving signals indicative of a child seat disposed on a seat adjacent to the door, monitor the activity of the user in the interior space of the motor vehicle.
